(19) United States
(12) Patent Application Publication
(10) Pub. No.: US 2012/0314604 A1
(43) Pub. Date: Dec. 13, 2012

(54) Methods and Arrangements for Performing Measurements in a Wireless Communication Network for Positioning or for Enabling Location-Based Services

(75) Inventors: Iana Siomina, Solna (SE); Ari Kangas, Lidingo (SE); Yang Zhang, Shanghai (CN)

(73) Assignee: TELEFONAKTIEBOLAGET LM ERICSSON (PUBL), Stockholm (SE)

(21) Appl. No.: 13/578,756

(22) PCT Filed: Oct. 6, 2010
(86) PCT No.: PCT/SE2010/051079

§ 371 Date: Aug. 13, 2012

(30) Foreign Application Priority Data
Feb. 12, 2010 (CN) PCT/CN2010/000198

(51) Int. Cl. H04W 24/00

(52) U.S. Cl. 370/252

(57) ABSTRACT

Method and arrangement in a positioning target node (130) such as e.g. a UE, for performing measurement on a reference signal for positioning or for enabling location-based services in a LTE network (100). The method comprises receiving a reference signal from a network node (110), (120), identifying at least one positioning subframe comprised within the received reference signal and performing measurement on the reference signal over the at least one identified positioning subframe. Also, a method and an arrangement in a network node 110, 120,140 are disclosed.

### TECHNICAL FIELD

The present solution relates in general to signal measurements in a wireless communication network and in particular to methods and arrangements for performing measurements in a wireless communications network for positioning or for enabling location-based services.

### BACKGROUND

User positioning, or identifying the geographical location of a user equipment (UE), has been widely used by a variety of services e.g. location-based services. The position of a UE may be accurately estimated by using positioning methods based on the Global Positioning System (GPS). However, GPS-based positioning may often have unsatisfactory performance in urban and/or indoor environments.

Another known positioning method is the Cell ID (CID)-based method where a UE position is estimated with the knowledge of the geographical coordinates of its serving eNodeB. Enhanced Cell ID (E-CID) positioning refers to techniques which use additional UE and/or Evolved Universal Terrestrial Radio Access Network (E-UTRAN) radio resource related measurements to improve the user UE estimate. For E-UTRAN access, these measurements may comprise UE measurements such as e.g. UE receive-transmit timing difference, Reference Signal Received Power (RSRP), etc. and E-UTRAN measurements such as e.g. eNodeB receive-transmit timing difference, etc. In earlier network generations, RSRP-type of measurement, for example, has been used in some variants of Cell ID-based positioning and also for neighbour list generation. Positioning support for LTE is being standardised but there is no reference solution for LTE yet.

Traditionally, RSRP and Received Signal Received Quality (RSRQ) or their equivalents in corresponding technologies, are the UE measurements that are used for mobility and for other Radio Resource Management (RRM) functions. For E-UTRAN, these measurements have been defined as follows:

Reference Signal Received Power (RSRP) is the linear average over the power contributions (in [W]) of the resource elements that carry cell-specific reference signals within the considered measurement frequency bandwidth.

Reference Signal Received Quality (RSRQ) is the ratio expressed as:

$$N \times \frac{RSRP}{RSSI}$$

where N is the number of resource blocks of the E-UTRA carrier Received Signal Strength Indicator (RSSI) measurement bandwidth. The measurements in the numerator and denominator may be made over the same set of resource blocks. E-UTRA Carrier RSSI is the linear average of the total received power (in [W]) observed only in Orthogonal Frequency-Division Multiplexing (OFDM) symbols containing reference symbols for antenna port 0, in the measurement bandwidth, over N number of resource blocks by the UE from all sources, including co-channel serving and non-serving cells, adjacent channel interference, thermal noise etc.

For E-CID positioning, signal strengths, Common Pilot CHannel (CPICH) Received Signal Code Power (RSCP) in Wideband Code Division Multiple Access (WCDMA); and the Broadcast Control Channel (BCCH) carrier RSSI in Global System for Mobile communication (GSM) have been used as fingerprints that are associated with high-accuracy position estimates obtained for the UE using, for example, Assisted Global Positioning System (A-GPS) method. After quantization, the measurements are tagged and then grouped in clusters with each cluster having measurements with the same tag and each cluster describing a subarea of a cell. RSRP could in principle be used for E-CID in LTE in a similar way as in GSM and WCDMA. It should be noted narrow-band signal strength measurements are known to suffer more from frequency-selective fading and thus be less reliable. The fading impact is therefore expected to be less for LTE than for GSM, for example.

Using RSRQ-equivalent measurements for E-CID in UTRAN has not been an attractive solution for terrestrial positioning, although the measurements may be reported to the Radio Network Controller (RNC). An explanation is that wide-band interference and power control make the interference more random and less correlated with geographical positions. In GSM, there exists a signal quality measurement Rx_qual, defined in Bit Error Rate (BER), which also has not been used for E-CID, although the measurement is available in the Base Station Controller (BSC).

Except E-CID, another possibility of using signal measurements in LTE is for Observed Time Difference Of Arrival (OTDOA) neighbour selection. Dense site locations and small frequency reuse factor make interference on Positioning Reference Signal (PRS) crucial for positioning performance. Furthermore, from the UE complexity point of view, it is considered important to not use very large neighbour lists since this may increase the measurement period and also increase false alarm probability. Hence, the neighbour cell list needs to be carefully selected. In UTRAN, Received Signal Code Power (RSCP)-based selection would be a straightforward approach for OTDOA neighbour lists due to the wideband interference and noise. However, OTDOA has not been realized in practice for UTRAN, so discussing existing solutions for positioning neighbour selection is not relevant with respect to UTRAN.

In GSM, the OTDOA variant is called Enhanced Observed Time Difference, or E-OTD, the time difference-based positioning method which requires LMUs to detect and report timing relation of different GSM cells. Conceptually, the GSM positioning method is similar to OTDOA in LTE. However, due to a typically large number of available frequencies and thus high frequency reuse, it is natural to base neighbour cell selection in GSM on signal strength measurements such as e.g. RSRP, rather than signal quality measurements such as e.g. RSRQ.

Another application of signal measurements, e.g. RSRP and RSRQ, is to hybridize the measurements with other available measurements, e.g. Reference Signal Time Difference (RSTD) or Timing Advance (TA), in areas with insufficient coverage of the necessary number of base stations.

In theory, the wide-bandwidth essence of LTE radio signal makes its strength less fluctuating than those narrow-band signals in mobile environment. Since there is no power control over LTE downlink, LTE signal strength detected at the UE side, for both serving cell and neighbour cell, is therefore even more stable for the same set of interferers than in other mobile systems. However, fluctuating is inevitable anyway.

In order to mitigate the fluctuating of received signal power some estimation/filtering methods may be combined, see FIG. 1. Such methods comprise: Simple average i.e. simply averaging the received signal power in dB, Optimum Unbiased estimation, Maximum likelihood estimation, Median filtering and/or Kalman filtering based method. Simulation over a short period, see FIG. 1, of real measurement data showing the effect difference of the enumerated methods.

As previously described signal measurements e.g. RSRP and RSRQ or their equivalents in corresponding technologies, are used for mobility which is not considered sensitive to fluctuation of the signal strength of the received signal power. But signal strength e.g. RSPP is considered too unreliable to be used for positioning purposes together with e.g. timing information, due to radio signal strength fluctuation. There are however filtering proposals to mitigate the fluctuation as discussed above, but residual fluctuating still cannot be considered negligible for positioning. Hence, there is a need for new measurements, or at least a new approach to the existing measurements, and methods of utilizing the measurements for positioning in e.g. LTE.

### SUMMARY

An object according to embodiments of the present invention is to alleviate at least some of the problems mentioned above and to provide a mechanism for performing signal measurements and utilize such measurements for positioning purposes in a wireless communication network such as LTE.

According to an aspect of the exemplary embodiments, at least the above stated problem is solved by means of a method in a positioning target node e.g. a UE, for performing measurement on a reference signal for positioning or for enabling location-based services in a wireless communication network. The method includes: receiving the reference signal from a network node; identifying at least one positioning subframe comprised within the received reference signal, and performing measurement on the reference signal over the identified positioning subframe(s) i.e. during the identified positioning subframe(s).

According to another aspect of the exemplar embodiments, at least the above stated problem is solved by means of an arrangement in a positioning target node such as e.g. a UE, for performing measurement on a reference signal for positioning or for enabling location-based services in a wireless communication network. The arrangement a receiver, configured to receive a reference signal from a network node. The arrangement further comprises a processor configured to identify at least one positioning subframe comprised within the received reference signal, and also configured to perform measurement on the reference signal over the at least one identified positioning subframe.

According to another aspect of the exemplar embodiments, at least the above stated problem is solved by means of method in a network node comprised in a wireless communication network, for positioning or for enabling location-based services. The method comprises: receiving a measurement from a positioning target node, where the measurement has been performed over at least one positioning subframe included within a reference signal and identified by the positioning target node. The method further comprises determining a geographical position of the positioning target node using the received performed measurement.

According to a further aspect aspect, the object is achieved by an arrangement in a network node for positioning or for enabling location-based services in a wireless communication network. The arrangement comprises a receiver configured to receive a measurement from a positioning target node, where the measurement has been performed over at least one positioning subframe included within a reference signal and identified by the positioning target node. The arrangement further comprises a processor configured to determine a geographical position of the positioning target node using the received performed measurement.

An advantage of embodiments is that due to that the positioning subframe(s) in the reference signal are low-interference subframes, reliable positioning determination is achieved using measurements performed on those low-interference subframes, even though fluctuation or residual fluctuation of the received signal power is present. The viability of the embodiments is also further improved using previously described estimation/filtering methods.

Another advantage of embodiments is to utilize new signal (quality) measurements for positioning is LTE.

Another advantage of embodiments is that positioning determination is improved because measurements performed are not subject or almost not subject to variations due to traffic load since the measurements are performed over or during positioning low-interference subframes in according with the embodiments.

Other objects, advantages and novel features of the herein described methods and arrangements will become apparent from the following detailed description.

### BRIEF DESCRIPTION OF THE DRAWINGS

The present methods and arrangements will now be described more in detail in relation to the enclosed drawings, in which:

FIG. 1 is a schematic illustration over a comparison between different known filtering approaches.

FIG. 2 is a block diagram illustrating a wireless communication network wherein the Exemplary embodiments of the present solutions may be implemented.

FIG. 3A is a combined flow chart and block diagram illustrating an exemplary embodiment of the present solution.

FIG. 3B is a combined flow chart and block diagram illustrating an exemplary embodiment of the present solution.

FIG. 4A is an illustration over different PRS patterns generated for different cell IDs.

FIG. 4B is an illustration over different CRS patterns generated for different cell IDs.

FIG. 5A is a flow chart illustrating an exemplary embodiment, in a positioning node, for building a database with neighbour cell lists.

FIG. 5B is a flow chart illustrating an exemplary embodiment of a method in a positioning node.

FIG. 5C is a flow chart illustrating an exemplary embodiment of the present method for utilizing measurements for positioning.

FIG. 6 is a schematic flow chart illustrating embodiments of a method in a positioning target node.

FIG. 7 is a block diagram illustrating embodiments of an arrangement in a positioning target node.

FIG. 8 is a schematic flow chart illustrating embodiments of a method in a network node.

FIG. 9 is a block diagram illustrating embodiments of an arrangement in a network node.

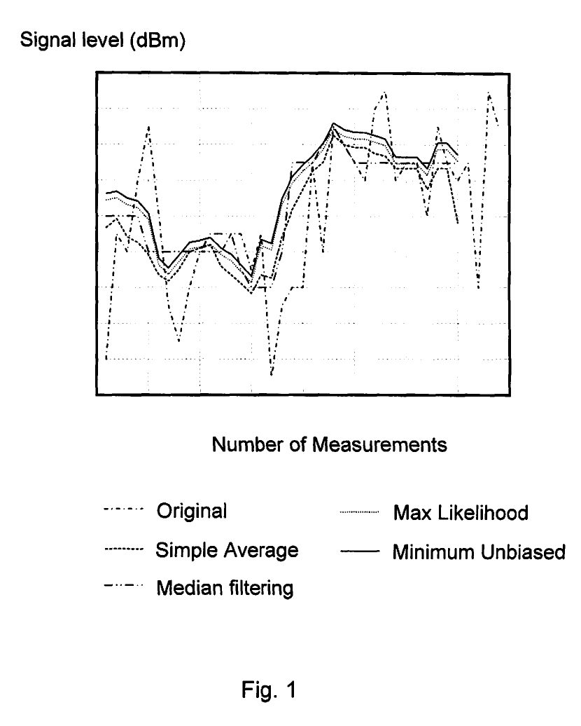

### DETAILED DESCRIPTION

The present disclosure relates in general to signal measurements in wireless communications networks and in particular to wireless network architectures that utilize signal measurements from one or several cells for positioning, location and location-based services. As will be described, there are provided a method and arrangement in a positioning target node and a method and arrangement in a network node, which may be put into practice in the embodiments described below. Note however that the methods and arrangements may be embodied in many different forms and should not be construed as limited to the embodiments set forth herein. There is no intent to limit the present methods and arrangements to any of the particular forms disclosed, but on the contrary, the present methods and arrangements are to cover all modifications, equivalents, and alternatives falling within the scope of the present solution as defined by the claims.

Some embodiments herein address positioning signal quality measurements, their signalling and usage for enhancing positioning in LTE. The concerned protocols are LTE Positioning Protocol (LPP) and LTE Positioning Protocol Annex (LPPa) and the signalling of these measurements are discussed below. It should be mentioned that positioning support for LTE is being standardised but there is no reference solution for LTE yet, although the means for signalling such measurements as RSRP and RSRQ, from a UE to a positioning node have been introduced in 3GPP. In LPP and LLPa, RSRP and RSRQ measurements have been introduced, with the intention to enhance UE-assisted E-CID positioning. For UE-based positioning, the measurements are readily available without signalling, though still without being restricted e.g. to certain subframes, therefore exemplary embodiments that will be described below are applicable for both UE-assisted and UE-based positioning approaches.

It should be mentioned that RSRP and RSRQ measurements have been included as elements of E-CID Signal Measurement Information, an information element used by a target device to provide various user equipment measurements to the location server as a part of the LPP message. By means of the LPPa protocol, RSRP and RSRQ measurements may also be requested by Evolved Serving Mobile Location Centre (E-SMLC) from eNodeB in E-CID Measurement Initiation Request. The available measurements, if obtained within the specified time, may then be sent to E-SMLC in an E-CID measurement report. If not available, the eNodeB may configure the user equipment to report the measurement information requested as specified in 3GPP TS 36.331.

The present solution may be carried out in other ways than those specifically set forth herein without departing from essential characteristics of the solution. The present embodiments are to be considered in all respects as illustrative and not restrictive, and all changes coming within the meaning and equivalency range of the appended claims are intended to be embraced therein.

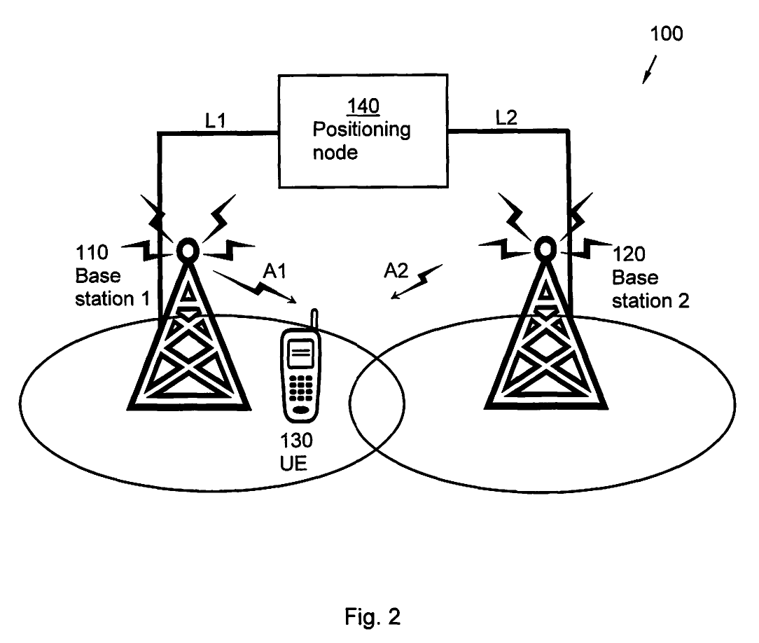

FIG. 2 is a schematic illustration over a wireless communication network 100. The wireless communication network 100 comprises a first base station 110 and a second base station 120. The wireless communication network 100 is further adapted to comprise a plurality of positioning target nodes 130, such as e.g. UE units. The base stations 110, 120 are configured send and receive wireless signals to and from the positioning target node 130 via a wireless interface, indicated by arrows A1 and A2. Further, the wireless communication network 100 comprises a positioning node 140, such as a positioning server. The first base station 110, the second base station 120 and the positioning node 140 may be referred to as network nodes.

Although two base stations 110, 120, one positioning node 140 and one positioning target node 130, such as a UE are depicted in FIG. 2, it is to be understood that another configuration of base stations or network nodes 110, 120, positioning nodes and UE units 130, respectively, may be comprised within the wireless communication network 100. FIG. 2 thus merely illustrates one possible network configuration out of plenty.

The exemplary connection links L1 and L2 illustrated in FIG. 2 are either logical e.g. over higher-layer protocols, or physical direct connections. Note also that in FIG. 2, logical links are illustrated since the base stations 110, 120 may have no direct connection to the positioning node 140, such as e.g. an E-SMLC, but they may be connected via e.g. a Mobility Management Entity (MME) although the positioning messages exchanged between the base stations 110, 120 and the positioning node 140 may be transparent, i.e. not readable for the MME.

The wireless communication network 100 may be based on technologies such as e.g. LTE or LTE-Advanced or their evolutions, Global System for Mobile Telecommunications (GSM), Enhanced Data rates for GSM Evolution (EDGE), General Packet Radio Service (GPRS), Code Division Multiple Access (CDMA), Wideband Code Division Multiple Access (WCDMA), CDMA 2000, High Speed Downlink Packet Data Access (HSDPA), High Speed Uplink Packet Data Access (HSUPA), High Data Rate (HDR) High Speed Packet Data Access (HSPA), Universal Mobile Telecommunications System (UMTS), Wireless Local Area Networks (WLAN), such as Wireless Fidelity (WiFi) and Worldwide Interoperability for Microwave Access (WiMAX), Bluetooth or according to any other wireless communication technology etc, just to mention some few none limiting examples.

The wireless communication system 100 may be configured to operate according to the Time Division Duplex (TDD) and/or the Frequency Division Duplex (FDD) principle.

Further, any, some or all of the base stations 110, 120 may be referred to as e.g. a Remote Radio Unit, an access point, a Node B, an evolved Node B (eNode B or eNB) and/or a base transceiver station, Access Point Base Station, base station router, a beacon device, a relay node, a cell site, a cell tower etc depending e.g. of the radio access technology and terminology used. Sometimes also the term cell is used by the skilled person, even in this present description, as a colloquial synonym to base station, even if that is not completely correct in a strict meaning as a cell rather denotes a geographical area covered by radio transmissions from a base station; and one base station may define a plurality of cells.

The wireless communication network 100 allows transmission/reception of information using a plurality of network nodes 110, 120, 140. The expression “downlink” (DL) is in the present context used to specify the transmission from the base station 110, 120 to the positioning target node 130, while the expression “uplink” (UL) is used to denote the transmission from the positioning target node 130 to the base station 110, 120.

In some embodiments, the positioning target node 130 may be represented by a (UE), a wireless communication device, a wireless communication terminal, a mobile cellular telephone, a Personal Communications Systems terminal, a mobile station (MS), a Personal Digital Assistant (PDA), a cell phone, a laptop, computer or any other kind of device configured for wireless communication. It may also be understood that the positioning target node 130 may be represented by a radio node in a broader sense, e.g. it may even be a radio base station, a pico node, a femto node, a micro node, a sensor, a relay node, a repeater etc. However, for enhancing the readability and understanding of the present disclosure, the term “positioning target node” will be consistently utilized in the subsequent description text.

The positioning target node 130 may further communicate with UE units not shown in FIG. 2, via at least the first or second base station 110, 120 comprised within the wireless communication network 100.

The positioning node 140 may be configured to determine the location of positioning target nodes 130 in the wireless communication network 100. The positioning node 140 may be e.g. a SMLC, or an Evolved SMLC (E-SMLC), according to some embodiments.

The positioning node 140 may optionally be associated with a database for storing data related to positioning of positioning target nodes 130 such as e.g. radio fingerprints derived from reference signal measurement data provided by the positioning target nodes 130. The database may reside internal or external to the positioning node 140 and may according to some embodiments be remotely connected to the positioning node 140. Also, the positioning node 140 may organise the data related to positioning of positioning target nodes 130 into groups having a same or similar radio fingerprint. The positioning node 140 may further determine the boundaries of each group and store the boundary information, associated radio fingerprints, and other position data information in the database. The positioning node 140 may subsequently receive measurement data from the positioning target node 130 and may perform a lookup into the database to identify a radio fingerprint stored in the database that matches the received reference signal measurement data, and to retrieve a geographic position stored in the database that corresponds to the matching radio fingerprint. According to some embodiments may the boundary information associated with the measurement data may be retrieved. The positioning node 140 may provide this geographic position data/boundary information to the positioning target node 130 that sent the radio fingerprint measurement data, or to other destinations, such as, for example, an emergency or police call centre etc.

It should me noted there is no decided solution (yet) for utilizing quality signal quality measurements for positioning in LTE. A-straightforward approach would be to adopt the approach used in earlier networks. Applicability of such approach and identified problems with the available measurements are discussed below, focusing on the following important aspects, what signal measurements are available for positioning in LTE, how to utilize signal quality measurements for OTDOA neighbour list selection and/or how to utilize signal quality measurements for positioning.

One problem is that it is currently not defined by the standard whether the signal quality measurements used for positioning (RSRQ so far) may be measured during positioning subframes or not, which makes a difference when used for mobility or positioning. Taking mobility measurements during positioning subframes may not be relevant in general if the data load needs to also be accounted for, which is usually the case for mobility.

Another problem is that RSRP and thus also RSRQ are generally defined for cell-specific reference signals, and RSSI is defined over the entire bandwidth, i.e. includes all the interference. This means that it has so far been justified to use these measurements for mobility and general radio resource management (RRM) functions.

Yet another problem is that a UE applies L1 filtering/higher-layer filtering and smoothing to RSRP and RSRQ without distinguishing between regular subframes and positioning subframes, although the measurements may greatly vary. A further problem may be that OTDOA, for example, though standardised for UTRAN, has not been actually used in practice and thus there is actually no implemented solution in products. Furthermore, as explained below, neighbour cell selection may be less trivial compared to earlier networks where RSRP-based selection has been a typical solution, i.e. a new approach is necessary.

RSRQ and RSSI (or their equivalents in the relevant technologies) have not been considered for neighbour list generation in earlier networks. In WCDMA, for example, this may be explained by spreading signals over the entire band and power control. Due to the wideband nature of interference and noise it is more natural to select the closest neighbours in terms of radio propagation, i.e. based on CPICH RSCP. The situation is different for OFDM where the interference is different on different subcarriers due to different signals transmitted on the corresponding Resource Elements (REs). Furthermore, the frequency reuse on Cell-specific Reference Signal (CRS) in LTE is not as high as in GSM, which makes the co-channel interference even more crucial in LTE, especially because there is no maximum co-channel interference requirement in LTE unlike in GSM. Yet a further additional problem, which has been previously described, is that signal strength (RSRP measurement) is too unreliable to be used for hybrid positioning together with timing information such as e.g. pseudo range, RSTD or TA. And signal strength in many cases does not correlate with geographical distance to eNodeB. There are, as previously described a lot of filtering proposals to mitigate this, but residual fluctuating still cannot be considered as negligible for positioning.

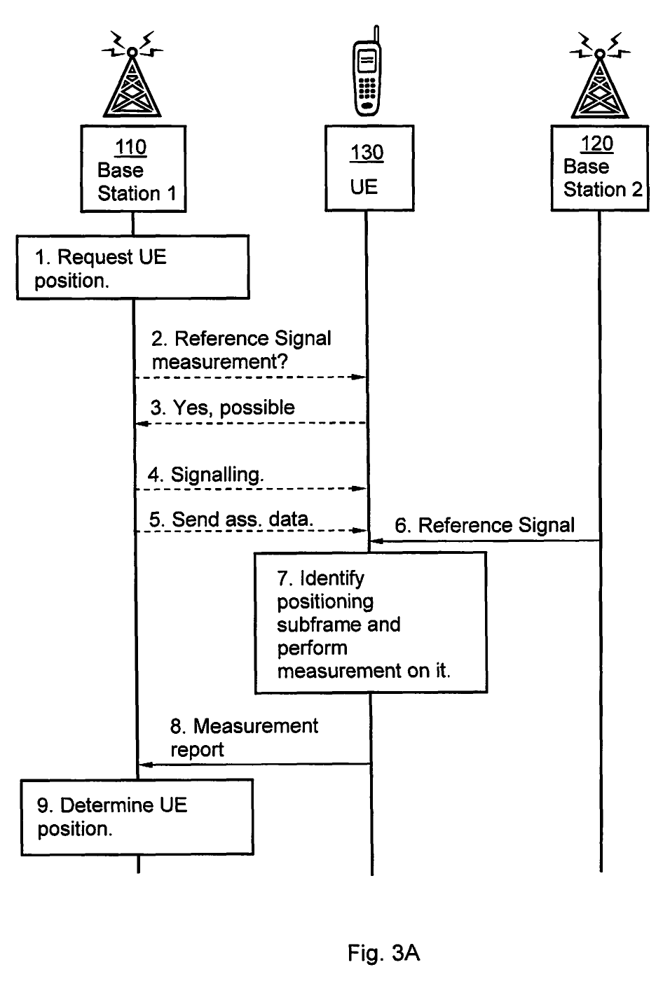

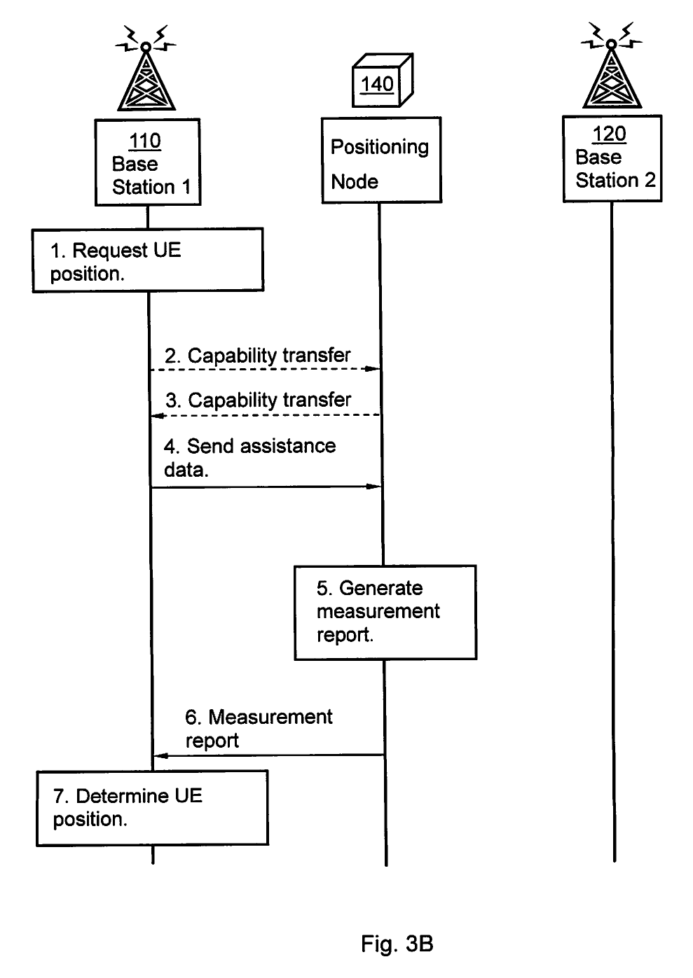

FIG. 3A illustrates an exemplary general overview of an embodiment of the present method.

The method may comprise a number of actions 1-9, in order to correctly perform a measurement on a reference signal, which measurement is related to the received power and/or quality of the reference signal, in the wireless communication network 100. The actions may be performed in a somewhat different order than the enumeration indicates, according to different embodiments.

### Action 1

According to some embodiments, a network node 110, 140 may request positioning of a particular positioning target node 130. The position request may be made by the positioning node 140 and sent over the protocol LPP transparently via the first base station 110.

According to some embodiments the reference signal measurements, measured e.g. on PRS, may be triggered by sending assistance data over LPP from the positioning node 140, e.g. E-SMLC or SLP, to the positioning target node 130, i.e. the request may not originate from the base station 110. There may be capability exchange between the positioning target node 130 and the positioning node 140 prior the assistance data, according to some embodiments.

### Action 2

In another optional action may a check if the positioning target node 130 is able to perform reference signal measurements be made. Thereby the positioning target node 130 may receive a request from the network node 110, 140, for confirming that the positioning target node 130 is able to perform the reference signal measurement over a positioning subframe such as e.g. a low-interference subframe, on a reference signal that may be PRS.

### Action 3

Having received a request from the network node 110, 140, for confirming that the positioning target node 130 is able to perform the measurement over the positioning subframe comprised in the reference signal or not, the positioning target node 130 may reply. If the answer is yes, the subsequent actions may be performed.

### Action 4

According to some embodiments may a positioning subframe indication be received by some other means, e.g. signalled by positioning node 140 to the positioning target node 130 e.g. over LPP or signalled from base station 110 e.g. over RRC. If such information is not received, then the positioning target node 130 may identify such positioning subframes autonomously or such subframes may be pre-defined e.g. being positioning subframes. When these subframes are positioning subframes, then the positioning target node 130 may identify these subframes based on the PRS configuration obtained from the positioning node 140 in the assistance data according to some embodiments.

### Action 5

A request or instruction triggering the positioning target node 130 to perform measurement on the reference signal may be transmitted, according to some embodiments.

### Action 6

The positioning target node 130 receives a reference signal from a network node 110, 120 such as e.g. a base station or a beacon device.

### Action 7

The positioning target node 130 identifies at least one positioning subframe comprised within the received reference signal, and performs a measurement over the at least one identified positioning subframe. Thereby may the measurement be performed such that no reference signal measurement is made on any subframe not identified as a positioning subframe, according to some embodiments.

The measurement report may be transmitted to the base station 110 as illustrated, but it also may be further transmitted to the positioning node 140, transparently to base station 110, over e.g. LPP, which positioning node 140 may also determine the position of the positioning target node 130, according to some embodiments.

### Action 8

The measurement performed on the reference signal is reported to the network node 110, 140 in a transmission, such that the determination of the geographical position of the positioning target node 130 is enabled, using the transmitted signal measurement.

### Action 9

The network node 110, 140 determines the (geographical) position of the positioning target node 130 based on the received measurement made on the reference signal.

The present methods further concern, according to some embodiments, to let the positioning target node 130 take signal measurements during positioning subframes, such as e.g. low-interference subframes, and report them separately. If the measured reference signal is transmitted on multiple ports, e.g. when positioning measurements are done on CRS, then each port may be measured and reported, according to some embodiments.

FIG. 3B illustrates yet an exemplary general overview of an embodiment of the present method.

The method may comprise a number of actions 1-8, in order to correctly perform measurement on a reference signal, which measurement is related to the received power and/or quality of the reference signal, in the wireless communication network 100. The actions may be performed in a somewhat different order than the enumeration indicates, according to different embodiments.

The signalling is performed in a similar way as for the previously described exemplary embodiment in FIG. 3A. The main difference is that in the example of FIG. 3B, the positioning node 140, instead of the positioning target node 130, may identify at least one positioning subframe comprised within the received reference signal, and perform a measurement on the reference signal over the at least one identified positioning subframe.

### Action 1

According to some embodiments may a first base station 110 request positioning of a particular positioning target node 130. The position request may be sent over the protocol LPP transparently according to some embodiments.

### Action 2 and 3

There may be an optional capability exchange between the positioning target node 130 and the base station 110 prior the assistance data, according to some embodiments.

### Action 4

A request or instruction triggering the positioning node 140 to generate a measurement report concerning the positioning target node 130 may optionally be transmitted. Such request or instruction may comprise further assistance data for enabling such measurement report, e.g. identity of the positioning target node 130 and signal measurements that has been performed by the positioning target node 130.

### Action 5

The positioning node 140 may further determine the position of the positioning target node 130, based on the received measurements and/or further assistance data.

### Action 6

The measurement report may be transmitted to the base station 110 over e.g. LPP, according to some embodiments.

### Action 7

The network node 110 determines the position of the positioning target node 130 based on the received measurement report.

According to some embodiments RSRQ-like signal quality measurements may be derived for PRS based on CRS measurements e.g. as described below.

Some advantages with those described embodiments may be that the standardized measurement definitions may be re-used, i.e. RSRP and RSRQ measured on CRS (still with RSSI over the entire bandwidth, though), as by definition, except that new measurement occasions, i.e. during positioning subframes, may additionally be considered.

The measurements are not subject, in synchronous networks, or almost not subject, in asynchronous networks, to variations due traffic load because positioning subframes are by definition low-interference subframes.

It may be defined in the standard, according to some embodiments, the relevant signal measurements specifically for PRS such as e.g. RSRP_PRS, RSRQ_PRS, RSSI_PRS, etc. that are performed over the same bandwidth as PRS is transmitted over. Let OTDOA-capable positioning target node 130 take signal measurements e.g. similar to RSRP, RSRQ, etc. on PRS and send the measurements to a network node 110, 120, 140 such as the positioning node 140, which may be an E-SMLC, or a base station 110, 120 such as an eNodeB directly, for example, over LPP and RRC, respectively. With the latter, the measurements delivered to the base station 110 may be further transmitted to the positioning node 140 (E-SMLC), e.g. by the protocol LPPa. Similarly, the request for these measurements may be sent over LPP or LPPa.

In another embodiment, the measurements may be taken and signalled selectively per carrier/carrier component, as may be instructed in the assistance data. In yet another embodiment, signal measurements over multiple carriers may be transmitted either in combined or separate per carrier positioning reports. In yet another embodiment, similarly, to RSRP for CRS, the similar measurement for PRS may also be defined for IDLE mode for the serving cell, e.g. for background UE tracking. In a further embodiment, the measurement definition may not be limited to a single antenna port, but may be defined and be reportable separately for as many antenna ports as the number of ports used for reference signals used for positioning measurements in the cell.

Some advantages of those embodiments may be mentioned. If PRS has, for example, better correlation properties than CRS, then even measurements similar to RSRP may be advantageous when conducted on PRS signals.

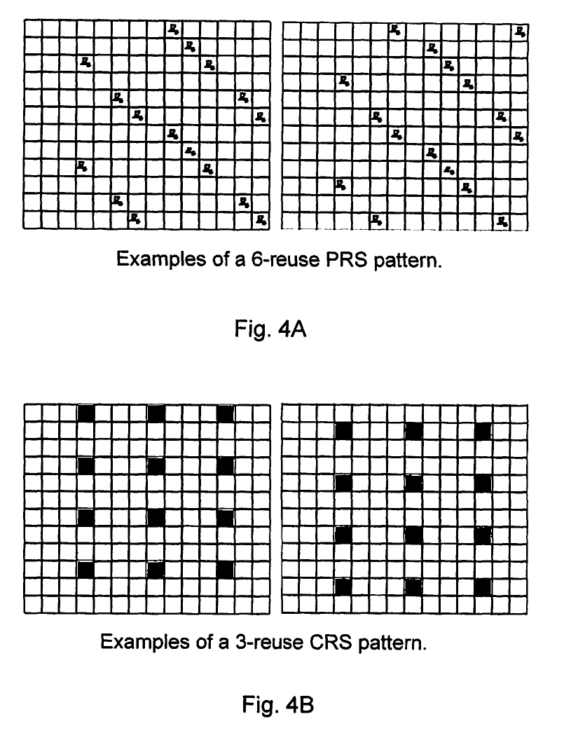

Different signals may be designed with different frequency reuse factor (e.g. frequency reuse for PRS is 6 and the typical frequency reuse for CRS is 3). In LTE, transmission patterns of physical signals are typically quite regular. Furthermore, frequency reuse may be modelled by shifting pre-defined patterns in frequency and associating the frequency shift with Physical Cell Identity (PCI) in a pre-defined way. An example is illustrated in FIG. 4A and FIG. 4B, where FIG. 4A illustrates an example of a 6-reuse PRS pattern and FIG. 4B illustrates an example of a 3-reuse CRS pattern for cell ID zero, and their frequency-shifted respective variants at the right side. It is to be noted that the methodology described in the section does not require the patterns to be exactly as illustrated in FIGS. 4A and 4B.

PRS may have better interference conditions e.g. as it is in the current standard, the frequency reuse on PRS is six, while the effective frequency reuse on CRS with a typical two-antenna setup is three.

Note that the method according to the described embodiments does not necessarily concern measurement of the wide-band interference. Positioning signal quality measurements different from those currently used for CRS may be defined in order to exclude unnecessary interference, e.g. defined the measurements only on PRS resource elements (REs) or CRS Res, if used for positioning. It may be noted that the RSRP-type of measurement (the nominator of the currently defined RSRQ) may not be excessively changed, except being defined also for PRS or for reference signals in general; however, the RSSI-type of measurement (denominator of the currently defined RSRQ) may be defined only for the corresponding REs. In another embodiment, measurements during positioning subframes, specifically on PRS, may be conducted by default when positioning occasions occur or may be optionally triggered by positioning protocols e.g. LPP when the corresponding signal measurements are requested from the positioning target node 130, or LPPa when requested from the base station 110. In another embodiment, for backward compatibility, the method by default may not apply to the positioning target node 130 that does not support this feature, provided that this is known to the network node 110, 120, 140. In yet another optional embodiment, different signal measurements may be taken on different carriers with an indication included in the report such as e.g. a boolean indicator is true if the measurements have been taken on the same or the main carrier.

According to some embodiments may positioning subframes be excluded when performing mobility or general Radio Resource Management (RRM) measurements, or measured separately on positioning and non-positioning subframes. It may also be mentioned that positioning subframes used for positioning measurements are not necessarily used for timing measurements and not necessarily containing PRS.

According to some embodiments may a reference signal quality be estimated based on the average signal quality measurements for the other reference signal in synchronized networks.

Interference may be a component of a signal quality metric. Another component may be the received signal strength of the measured signal. It is herein assumed that measurements for reference signal RS0 may be performed, such as e.g. CRS, and that it is desired to estimate the interference on another reference signal RS, such as e.g. PRS. Since deriving the received power relation for the two signals is straightforward given the average gain factor and transmit power relation, the average received signal power may be calculated. In the subsequent section is focused on interference relation for the two signals, i.e. on deriving interference for RS, given the interference for RS0. With the known interference and the received signal power, the received signal quality for the reference signal may then also be determined.

In an Orthogonal Frequency-Division Multiplexing (OFDM) system, transmissions occur on a large number of orthogonal subcarriers. For each subcarrier, the interference may thus in principle be viewed as narrow-band interference, meaning that a signal transmitted on a subcarrier is interfered only by signals transmitted in other cells on the same subcarrier.

Consider a positioning target node 130. Below is modelled interference Iᵢ^{(RS)} to a reference signal e.g. PRS on a subcarrier in one OFDM symbol (one resource element) as experienced at the UE location:

Iᵢ^{(RS)}=Σ_{lεΩ}_{ᵢ}^{(RS)}pₗ^{(RS)}gₗ+Σ_{lεΩ\{i∪Ω}_{ᵢ}^{(RS)}_{}}pₗ^{(tr)}gₗ+v [Equation 1]

where:

Ω is the set of all cells,

Ωᵢ^{(RS)}={lεΩ\i:mod(l,λ^{(RS)})=mod(i,λ^{(RS)})} is the set of cells that transmit the same-type reference signal as cell i, assuming a frequency reuse factor λ^{(RS)} among the cells for the given reference signal. It may be noted that:

Ωᵢ^{(RS)}=Ω when λ^{(RS)}=1

gₗ is the average total path gain between the transmitter and the UE receiver,

pₗ^{(RS)} and pₗ^{(tr)} are the average reference signal and traffic transmit power levels per resource element, respectively,

v is the average noise power, which may be modelled as the expected value of a Gaussian random variable.

The traffic power per resource element in a cell (cell l) is the total power in the cell transmitted on non-reference signal resource elements divided by the total number of resource elements within the measured bandwidth of cell i that are not used for reference signals, including the subcarriers that fall outside the measured bandwidth of reference signals of cell l (if smaller than that of the cell i or those that remain unloaded in cell l. Note that in equation (1), interference from traffic may also comprise interference from other type of reference signals, which does not occur, for example, in the currently standardized solution with a synchronized LTE network.

When the measurements for reference signal cannot be obtained such as e.g. when not defined by the standard, it may be useful to derive interference from one frequency reuse factor to another frequency reuse factor, without explicit signalling signal quality measurements for each type of signals. Such transformation for LTE simplifies due to the fact that there is no power control in LTE downlink, although the average power per resource element may still vary among different signals because of power boosting/deboosting. Below is the transformation for a reference signal RS0, characterised by frequency reuse factor, derived. With this transformation, the interference on a subcarrier where RS0 is transmitted may be as follows:

$$[ Equation 2 ]$$

$${I}_{i}^{( RS 0 )} = {\sum }_{l ∈ {Ω}_{i}^{( RS 0 )}} {p}_{l}^{( RS 0 )} {g}_{l} + {\sum }_{l ∈ Ω \backslash \{ i ⋃ {Ω}_{i}^{( RS 0 )} \}} {p}_{l}^{( tr 0 )} {g}_{l} + v == [ \begin{matrix}( {\sum }_{l ∈ {Ω}_{i}^{( RS )}} {p}_{l}^{( RS )} {g}_{l} + {\sum }_{l ∈ {Ω}_{i}^{( RS )}} ( {p}_{l}^{( RS 0 )} - {p}_{l}^{( RS )} ) {g}_{l} ) - \\ - {\sum }_{l ∈ {Ω}_{i}^{( RS )} \backslash {Ω}_{i}^{( RS 0 )}} {p}_{l}^{( RS 0 )} {g}_{l} + {\sum }_{l ∈ {Ω}_{i}^{( RS 0 )} \backslash {Ω}_{i}^{( RS )}} {p}_{l}^{( RS 0 )} {g}_{l}\end{matrix} ] ++ [ \begin{matrix}( {\sum }_{l ∈ Ω \backslash \{ i ⋃ {Ω}_{i}^{( RS )} \}} {p}_{l}^{( tr )} {g}_{l} + {\sum }_{l ∈ Ω \backslash \{ i ⋃ {Ω}_{i}^{( RS )} \}} ( {p}_{l}^{( tr 0 )} - {p}_{l}^{( tr )} ) {g}_{l} ) - \\ - {\sum }_{l ∈ {Ω}_{i}^{( RS 0 )} \backslash {Ω}_{i}^{( RS )}} {p}_{l}^{( tr 0 )} {g}_{l} + {\sum }_{l ∈ {Ω}_{i}^{( RS )} \backslash {Ω}_{i}^{( RS 0 )}} {p}_{l}^{( tr 0 )} {g}_{l}\end{matrix} ] + v == {I}_{i}^{( RS )} + {\sum }_{l ∈ {Ω}_{i}^{( RS )}} ( {p}_{l}^{( RS 0 )} - {p}_{l}^{( RS )} ) {g}_{l} + {\sum }_{l ∈ Ω \backslash \{ i ⋃ {Ω}_{i}^{( RS )} \}} ( {p}_{l}^{( tr 0 )} - {p}_{l}^{( tr )} ) {g}_{l} ++ {\sum }_{l ∈ {Ω}_{i}^{( RS )} \backslash {Ω}_{i}^{( RS 0 )}} ( {p}_{l}^{( tr )} - {p}_{l}^{( RS 0 )} ) {g}_{l} + {\sum }_{l ∈ {Ω}_{i}^{( RS 0 )} \backslash {Ω}_{i}^{( RS )}} ( {p}_{l}^{( RS 0 )} - {p}_{l}^{( tr )} ) {g}_{l}$$

Equation 2 uses the following sets defined with respect to cell i:

Ωᵢ^{(RS)}=all cells having the same pattern for the RS as cell i, excluding i,

Ωᵢ^{RS0}=all cells having the same pattern for RS0 as cell i, excluding i,

Ω\{i∪Ωᵢ^{RS}}=all cells having a pattern of RS different from that in cell i,

Ω\{i∪Ωᵢ^{RS0}}=all cells having a pattern of RS0 different from that in cell i,

Ωᵢ^{RS0}\Ωᵢ^{RS}=all cells having the same pattern for RS0 as cell i, but a pattern for RS different from that in cell i,

Ωᵢ^{RS}\Ωᵢ^{RS0}=all cells having the same pattern for RS0 as cell i, but a pattern for RS different from that in cell i.

In equation 2 is further:

pₗ^{(tr)}=the average power per non-RS resource elements, and

pₗ^{(tr0)}=the average power per non-RS0 resource elements.

Equation 2 may be simplified in some special cases, e.g. when the second term is zero when the power levels per resource elements for reference signals RS and RS0 are the same. Another such case may be when the last and the second last terms are zero and when the average power per resource element for the reference signals and traffic are the same. This may occur, for example, at full system load assuming the same frequency-domain average power on all resource elements). Yet such a case may be when the last term is zero when:

Ωᵢ^{(RS0)}⊂Ωᵢ^{(RS)}

with an equality when, e.g. the patterns of RS0 and RS are the same, and with the first set to be a subset of the second one when, e.g. when RS0 has a higher frequency reuse than RS and the interfering cells to cell i on RS0 are also the interfering cells on RS but not the other way around.

With the above, given the average interference on CRS resource elements (frequency reuse of three with two transmit antennas) and under the assumption of the same transmit power per resource element for CRS and PRS and the same power on non-reference signal resource elements in CRS and PRS symbols e.g. when both measured in positioning subframes, the average interference reduction on PRS resource elements (frequency reuse of six) compared to that on CRS resource elements may be estimated from equation (2) as follows:

Iᵢ^{(CRS)}−Iᵢ^{(PRS)}=Σ_{lεΩ}_{ᵢ}^{(CRS)}_{\Ω}_{ᵢ}^{(PRS)}(pₗ^{(CRS)}−pₗ^{(tr}^{_{CRS}}⁾)gₗ [Equation 3]

In practice, there may not be given received powers for all cells in Ω-sets. However, the measured received powers of the strongest cells may typically be available, which allows to obtain the most significant part of the interference reduction using equation (2) or using equation (3) in a special scenario assumed in the example above with CRS and PRS. Equation (2) may be utilized, for example, for neighbour cell selection for OTDOA positioning when measurements are performed on PRS, but only CRS signal quality measurements are available.

Note that Equations (2) and (3) may be utilized in case the interference is measured on the interfering resource elements. When the interference is measured over the entire bandwidth, e.g. like RSSI is defined, the interference does not depend on the measured signal and may thus be the same for PRS and CRS if the same type of measurements is used for PRS and CRS, both in synchronized and non-synchronized networks. It is, however, possible that the measurements for CRS are as given, but interference estimation on PRS resource elements is desired. The average interference reduction on PRS compared to what is obtained with RSRQ measurements may then be also calculated from Equation (2). For example, under the assumption of the same transmit power per resource element for CRS and PRS, zero traffic power on PRS symbols (i.e. low-interference positioning subframes), and average load factor pₗ on non-CRS resource elements in cell l relative to pₗ^{(CRS)} the interference reduction becomes as follows, in Equation 4:

$${RSSI}_{i}^{( CRS )} - {I}_{i}^{( PRS )} = {\sum }_{l ∈ Ω} ( \frac{1}{{λ}^{( CRS )}} {p}_{l}^{( CRS )} + ( 1 - \frac{1}{{λ}^{( CRS )}} ) {ρ}_{l} {p}_{l}^{( CRS )} ) \cdot {g}_{l} -- ( {\sum }_{l ∈ Ω \backslash \{ i ⋃ {Ω}_{i}^{( RS )} \}} {ρ}_{l} {p}_{l}^{( CRS )} \cdot {g}_{l} - {\sum }_{l ∈ {Ω}_{i}^{( RS )} \backslash {Ω}_{i}^{( RS 0 )}} {p}_{l}^{( CRS )} {g}_{l} + {\sum }_{l ∈ {Ω}_{i}^{( RS 0 )} \backslash {Ω}_{i}^{( RS )}} {p}_{l}^{( CRS )} {g}_{l} ) == {\sum }_{l ∈ ( i ⋃ {Ω}_{i}^{( RS )} )} ( {ρ}_{l} + \frac{1 - {ρ}_{l}}{{λ}^{( CRS )}} ) \cdot {ρ}_{l}^{( CRS )} {g}_{l} - {\sum }_{l ∈ Ω \backslash \{ i ⋃ {Ω}_{i}^{( RS )} \}} \frac{1 - {ρ}_{l}}{{λ}^{( CRS )}} \cdot {p}_{l}^{( CRS )} {g}_{l} ++ {\sum }_{l ∈ {Ω}_{i}^{( RS )} \backslash {Ω}_{i}^{( RS 0 )}} {p}_{l}^{( CRS )} {g}_{l} - {\sum }_{l ∈ {Ω}_{i}^{( RS 0 )} \backslash {Ω}_{i}^{( RS )}} {p}_{l}^{( CRS )} {g}_{l}$$

An embodiment of a method of using signal quality metrics for positioning neighbour list selection will now be described.

As has been mentioned previously, neighbour list selection in OTDOA-like solutions in the prior art is typically based on the received power strength. In LTE, however, due to the importance of co-channel interference impact, it is desirable to take into account interference on reference signals used for positioning (e.g. PRS or CRS) when designing OTDOA neighbour lists. In some embodiments, a metrics that reflect the impact of interference may be utilized. Such metrics may, for example, be RSRQ (even if PRS and not CRS is used for positioning) when this is the best suitable measurement type which is available, preferably measured during positioning subframes. RSRQ-like measurement for PRS when RSRQ for CRS is available and it is possible to derive a similar measurement for PRS. Signal to Interference and Noise Ratio (SINR)-like measurement accounting for interference only on the reference signals used for positioning, e.g. either CRS or PRS. Relative received power strength of the measured cell with respect to the reference cell.

Here the serving cell could, for example, be the reference cell at the UE location, e.g.

$$\frac{{p}_{i} {g}_{ij}}{{p}_{r} {g}_{rj}}$$

where:

pᵢ and pᵣ are the transmit power levels of reference signal used for positioning by a neighbour cell i and reference cell r, respectively, and gᵢⱼ and gᵣⱼ are the total power gain levels between the UE j and neighbour cell i and reference cell r respectively. The metric may capture the impact of the major interference on the signal quality metric of a non-reference cell, which may be assumed to be a cell with a good signal quality, e.g. the serving cell, the reference cell or one of the strongest cells. Note also, that cell r in the metric may actually be different in different subframes or positioning occasions when, for example, muting is applied.

In principle, any of the metric above may be used for neighbour selection. Also, to select neighbour cells, a reference cell for each positioning target node 130 may have to be known. It may be advantageous to not always assume the serving cell to be the reference cell, as previously mentioned. So, a positioning server 140, in addition to the positioning neighbour selection task, may also select the best reference cell for a positioning target node 130 with respect to some criteria. The metrics discussed above for the positioning neighbour list selection, could also be used for the reference cell selection.

This basic selection strategy both for the reference cell selection and positioning neighbour cell list selection may comprise any, some or all of the following components:

Part 1: Choosing/prioritizing the cells that have a higher quality metric, e.g. arrange the list of candidate cells in the decreasing order of Signal to Interference and Noise Ratio (SINR) on signals measured for positioning or other metric and peak the first N cells, where N is the number of cells of interest, e.g. the neighbour list size or N=1 for the reference cell selection.

Part 2 (optional): Prioritize cells that are in line of sight from the UE point of view. The line of sight status may be reckoned based on some further calculation, e.g. compare the neighbour signal (interference) strength with ideal path loss model or possibly use the channel estimation, select those “close” ones.

In Part 1, when defining cell neighbour lists and selecting reference cells, it may be desirable to not base the decisions on instantaneous measurements. instead, for example, one of the filtering alternatives previously discussed may be utilized before the cells are compared to make the selection decision according to some embodiments.

The aim of the algorithm, Part 1, is to provide a set of cells of a given size, for example specifically per positioning target node 130, but in practice the lists may be designed for a group of positioning target nodes 130 with similar characteristics e.g. positioning Quality of Service (QoS) requirements, subscription conditions, subscriber group, etc. per area and/or per cell, such that the generated lists may be stored in a database and then used for multiple positioning target nodes 130. The lists may either be statically designed or updated e.g. periodically or in real time upon receiving a trigger. A list associated with a group of positioning target nodes 130, areas and/or cells may be sorted in some order, e.g. decreasing expected signal quality from cells (different weights may also apply for different cells), such that when a neighbour list of a smaller size is requested, the first N neighbour cells may be taken from the list stored in the database. Sorting the neighbour cell lists in some order of preference from the positioning target node 130 perspective may also allow the positioning target node 130 to select the desired number of cells from the received neighbour cell list with the maximum possible number of neighbours, which is not necessarily the optimal from the positioning target node 130 complexity point of view.

The database may be constructed following the actions below:

1) Collect the measurements statistics from multiple positioning target nodes 130,

2) Group and tag the measurements,

3) Generate a neighbour cell list for each tag,

4) Build/update a database of neighbour cell lists associated with each tag.

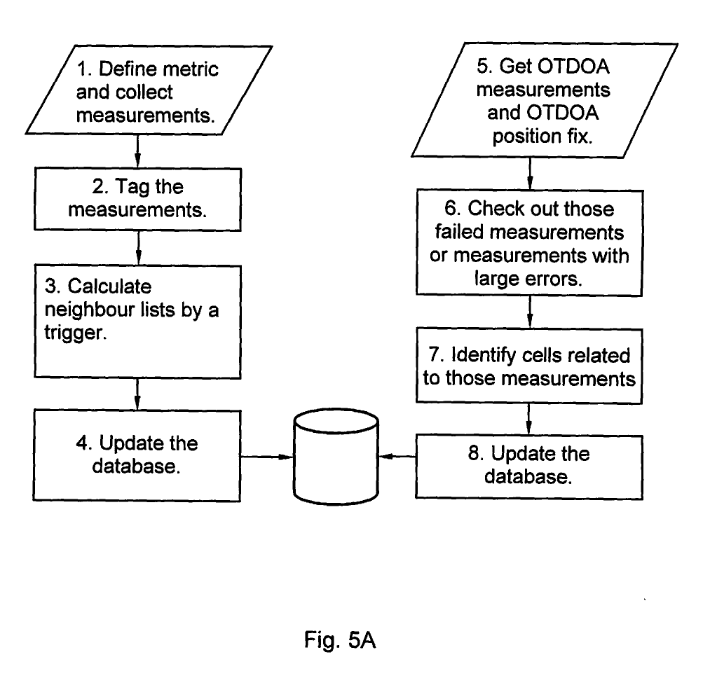

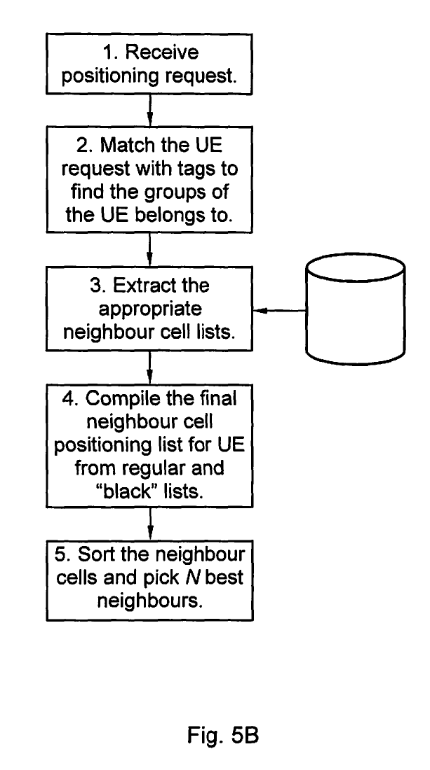

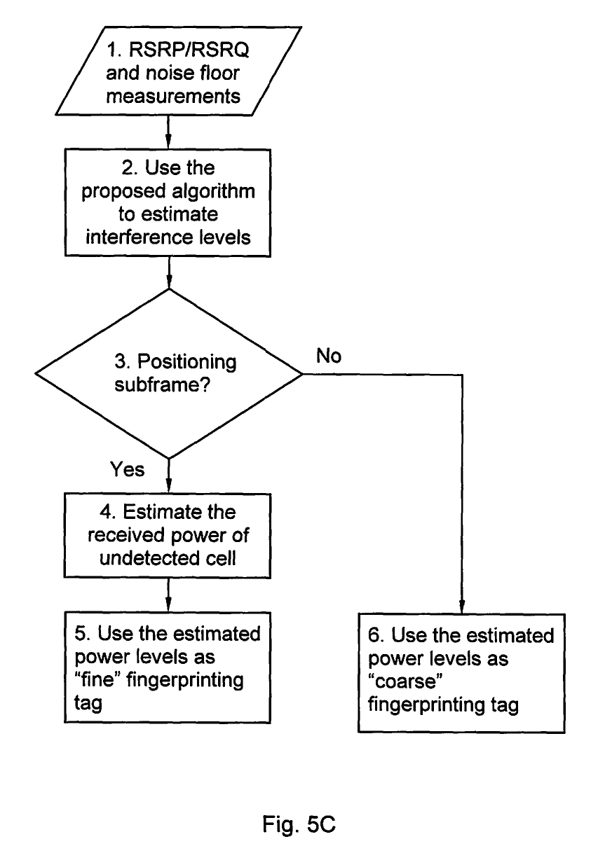

When a positioning request is received, the network may have some rough estimation of the positioning target node position based, for example, on cell ID, timing advance, etc. This rough position may then be mapped onto some tag and the associated neighbour list stored in the database may then be extracted. Multiple lists may be extracted for a positioning target node 130, which then may be compiled into one final list, see FIGS. 5A and 5B.

FIG. 5A describes a method in a positioning node 140 for building up and updating a data base with neighbour cell lists.

The method may comprise a number of actions 1-8, in order to correctly building up and updating a data base with neighbour cell lists in the wireless communication network 100. The actions may be performed in a somewhat different order than the enumeration indicates, according to different embodiments.

The actions 1-4 on the left side of FIG. 5A describes the process of generating neighbour cell lists while the right side flow, actions 5-8 describes an OTDOA feedback based way of ensuring that the failed neighbour cells are excluded from the positioning neighbour list.

### Action 1

Metrics are defined and measurements are collected. The measurements may comprise e.g. signal quality measurements.

### Action 2

The measurements may be received, grouped and tagged, according to any appropriate criterion.

### Action 3

Neighbour lists are calculated, based on the performed measurements. The calculation may be initiated by a trigger, e.g. if the tag is new, or periodically at a certain time interval, which may be predetermined.

### Action 4

The database is updated. Thus the calculated neighbour lists may be added to the data base.

### Action 5

OTDOA measurements and OTDOA positions may be obtained.

### Action 6

Failed measurements or measurements with large errors may be checked.

### Action 7

Cells related to failed measurements or measurements with large errors may be identified.

### Action 8

The data base is updated. The cells identified as transmitting signals where the measurements (on those signals) comprise large errors may be excluded from the positioning neighbour list in the data base.

There may be multiple UE groups and the positioning target node 130 may belong to more than one group. A neighbour list may be associated with each group. A neighbour cell list may also be designed as a “black neighbour cell list”, so that the cells in the black list are not comprised in the final regular neighbour list signalled to the positioning target node 130. Cells may be comprised in “black” lists for various reasons, e.g. poor signal quality or restricted access, closed subscriber groups, etc. The final list may be the union of regular neighbour cell lists associated with multiple groups to which the positioning target node 130 belongs, excluding the cells from “black” lists associated with other groups of which the positioning target node 130 is a member of. Using “black” list allows for reducing unnecessary overhead and redundancy in the database.

FIG. 5B describes a method in a positioning node 140 for obtaining neighbour lists for a UE.

The method may comprise a number of actions 1-5, in order to correctly obtain neighbour lists for a UE in the wireless communication network 100. The actions may be performed in a somewhat different order than the enumeration indicates, according to different embodiments.

### Action 1

A positioning request may be received.

### Action 2

The received positioning request may be matched or parsed with tags, to find the group the UE is comprised within.

### Action 3

The appropriate neighbour cell list may be extracted from the data base.

### Action 4

The final neighbour cell positioning list for the UE may be extracted from regular and “black” lists.

### Action 5

The neighbour cells may be sorted. The best neighbour cells may be selected.

A method of using signal quality measurements for positioning will now be described.

As previously described, there exist areas where there may be an advantage to combine multiple measurements, possibly of different types, in order to achieve the desired accuracy. This may occur, for example, due to too few visible satellites for A-GPS, insufficient number of base station for OTDOA, etc. i.e. when some information may need to be derived to resolve the position ambiguity.

It may be derived from equation (1) that given total interference Iᵢ^{(RS)}, the received signal power levels from some (detected) cells e.g. obtained from RSRP measurements in LTE as well as the noise power, which typically may be estimated, and the received power from the other cells may be estimated.

In this way, even if not detected, such one or more cells may contribute with this extra information to a positioning method based on fingerprinting, if the total received power of such cells is viewed as a “hidden aggregate fingerprint”. When being tagged for a fingerprint database, it may be sufficient to store only the total interference since different hidden fingerprints could then be derived based on the other available information.

Furthermore, in some special cases even more information may be extracted. Observe that when there is no interference from data transmissions, e.g. in positioning subframes when viewed as low-interference subframes, the second summation may be zero. Such interference-free measurement could be an even better fingerprinting tag compared to the proposal right above. With a small set of cells that are expected to be interfering in the UE geographical area, a trivial upper bound on the received power of undetected cells may be obtained. With one undetected cell, the received power of this cell may be in this way fully “recovered” and could be used for fingerprint matching in the way similar to that for detected cells.

The extracted interference strength may be used not only for fingerprinting, but also used to generate location estimate. With the help of some filtering mechanisms (see above), such combination may achieve an improved accuracy. FIG. 5C illustrates a non-limiting, exemplary flow of the method according to some embodiments.

FIG. 5C describes a flow for utilizing measurements for positioning.

The method may comprise a number of actions 1-6, in order to correctly utilizing measurements for positioning. The actions may be performed in a somewhat different order than the enumeration indicates, according to different embodiments.

### Action 1

RSRP/RSRQ and/or noise floor measurements may be obtained.

### Action 2

The presently proposed algorithm may be utilized to estimate interference levels.

### Action 3

A check may be performed, checking if any positioning subframe is detected.

### Action 4

If a positioning subframe is detected, the received power of undetected cell may be estimated.

### Action 5

The estimated power levels may be utilized as “fine” fingerprinting tag.

### Action 6

If a positioning subframe is not detected, the estimated power levels may be utilized as “coarse” fingerprinting tag.

At least the following advantages may be seen with the current solution:

New measurements and measuring approach comprising e.g. measuring during positioning subframes are presented.

Signalling to support the measurements is proposed, e.g. RSRQ-like or SINR-like on PRS measurements needs to be then allowed in LPP and LPPa—currently the RSRQ and RSRP are only possible, which is not really relevant for positioning.

New opportunities for fingerprinting positioning methods (e.g. AECID) to enhance accuracy in LTE positioning. The algorithm output may be further used in an E-UTRAN Cell Global Identifier (ECGI) method to generate location estimate.

Embodiments of the method for positioning neighbour cell list selection proposed which is designed while taking into account disadvantage of the state of the art methods and approaches, if they were adopted for LTE.

The proposed measurements and metrics may further be utilized, for example, for radio network planning, comprising e.g. cell ID planning and/or re-configuration/optimization could be an input to the network O&M block and also utilized for network self-optimization. Another possible application is UE tracking.

There may be an impact on radio base stations 110, 120 if new measurements are introduced—radio base stations 110, 120 may be informed at least the measurements, especially if their use is not limited to positioning. But even for positioning, LPPa may be impacted and this is between the first base station 110 and the positioning node 140.

Furthermore, the same for the core network in general—for, example, if the new measurements are to be used for general O&M.

Embodiments disclose features of signalling new LPP or LPPa features; on measurements and measurement approaches, which may be generalized to reference signals used for positioning, which may comprise PRS and CRS. Also, on the application of embodiments of the presently described measurements such as PRS power control, neighbour cell selection, etc. Furthermore, on the method of using the discussed metrics, not necessarily limited to the disclosed measurement method, for cell neighbour selection and reference cell selection. Note: the application of the proposed optimization approach and probably even the set of metrics may also be extended for neighbour cell selection in general, not necessarily positioning only, and also for general Operations, Administration, and Maintenance (OAM). UE tracking is another possible application. Additionally, the discussed metrics may be utilized for enhancing hybrid positioning.

The present mechanism for signal measurement related mechanism in the LTE radio communications network may be implemented through one or more processors, such as a processor in the positioning node 140, in the positioning target node 130 or such as a processor in the first base station 110, together with computer program code for performing the functions of the present solution. The program code mentioned above may also be provided as a computer program product, for instance in the form of a data carrier carrying computer program code for performing the present method when being loaded into the positioning target node 130, positioning node 140 or the radio base station 110. One such carrier may be in the form of a CD ROM disc. It is however feasible with other data carriers such as a memory stick. The computer program code may furthermore be provided as program code on a server and downloaded to the positioning target node 130, the positioning node 140 or the radio base station 110.

Modifications and other embodiments of the disclosed methods and arrangements will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

### Some Particular Embodiments

A method for measuring a received signal power level from a cell as well as the noise power, estimating a received signal power level from a different cell, wherein the measuring is performed on a reference signal used for positioning or just signalled in a positioning subframe.

A UE configured to perform a signal measurement on a reference signal related to a positioning reference signal during positioning subframes or just a signal signalled with the positioning subframe from a radio base station 110, wherein the UE is further arranged to report the signal measurement per positioning subframe separately to a positioning node 140 or a radio base station 110.

An LTE Positioning Protocol ‘LPP’ or LTE Positioning Protocol Annex ‘LPPa’ comprising a signal measurement of a positioning reference signal or a signal used for positioning or a signal in general which is signalled in a positioning subframe.

A method in a positioning node 140 of using metrics for cell neighbour selection and reference cell selection.

A method in a positioning node 140, wherein the method uses the metrics for enhancing hybrid positioning.

A method in a positioning node 140 for obtaining neighbour cell list for a UE according to any of FIG. 5A or 5B where the lists are being used for positioning, general O&M or UE tracking.

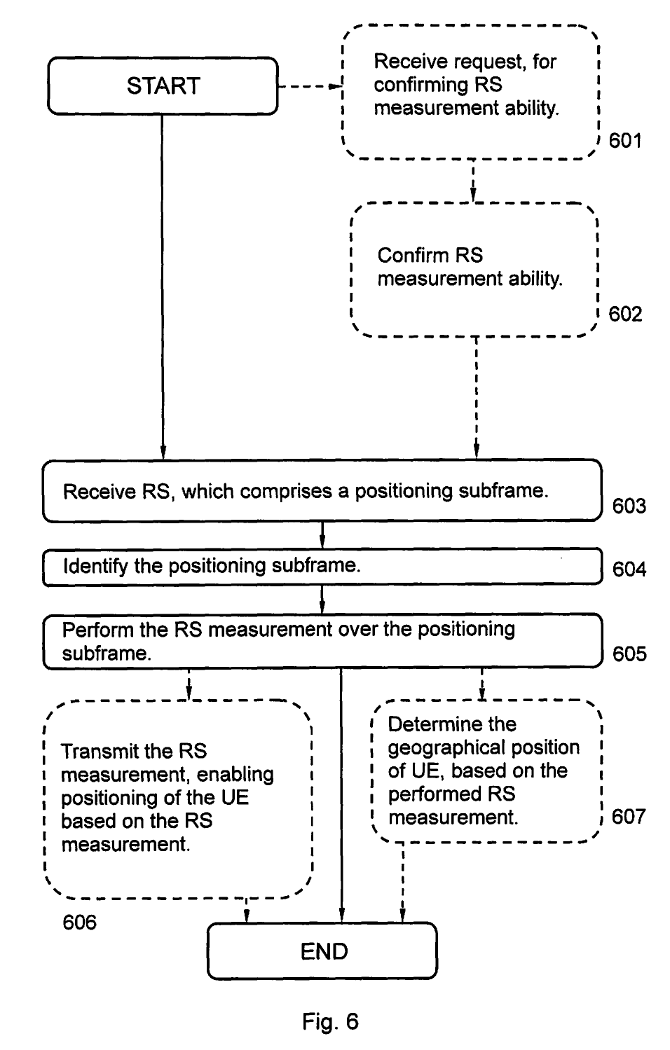

FIG. 6 is a schematic block diagram illustrating an embodiment of the present method in a positioning target node 130. The positioning target node 130 may be represented by a UE, or e.g. a base station, pico node or the like. The method aims at performing measurement on a reference signal for positioning or for enabling location-based services in a wireless communication network 100. The measurement may thus be related to the received signal power and/or quality of the reference signal. The positioning subframe is a low-interference subframe and the reference signal may be e.g. a positioning reference signal (PRS) or a cell-specific reference signal (CRS).

The wireless communication network 100 may comprise a first base station 110, acting as serving or reference base station for the positioning target node 130 according to some embodiments. Further the wireless communication network 100 may comprise a positioning node 140 according to some embodiments.

The method may comprise a number of actions 601-607, in order to correctly perform measurements on the reference signal. The actions 601-607 may be performed in a somewhat different order than the enumeration indicates, according to different embodiments. Further, it is to be noted that some of the actions are optional, indicated by dashed lines in FIG. 6, and may be comprised only according to some embodiments.

### Action 601

This action is optional and may be performed within some embodiments.

A request may be received from the network node 110, 120, 140 for confirming that the positioning target node 130 is able to perform the measurement on the reference signal over the positioning subframe.

### Action 602

This action is optional and may be performed within some embodiments. Information may optionally be transmitted to the network node 110, 120, 140, confirming that the positioning target node 130 is able to perform the reference signal measurement on the reference signal over the positioning subframe.

### Action 603

A reference signal is received from a network node 110, 120. The network node 110, 120 may be a base station 110, 120 or a beacon device according to some embodiments. A request for a reference signal measurement may optionally be received from the first base station 110, triggering the positioning target node 130 to perform the measurement on the reference signal over at least one positioning subframe, according to some embodiments.

### Action 604

At least one positioning subframe comprised within the received reference signal is identified. The action of identifying at least one positioning subframe comprised within the received reference signal may be performed autonomously by the positioning target node 130, with or without using any reference signal configuration information.

### Action 605

The measurement on the reference signal is performed over or during the at least one identified positioning subframe.

By identifying the positioning subframe/s comprised within the received reference signal, making a distinction between the positioning subframes and other subframes and performing the measurement only over the positioning subframes, the precision of the measurement may be improved. Since the positioning subframes are likely to be less influenced by interference, it is advantageous to perform the measurement over these subframes.

The measurement on the reference signal may optionally be performed when a positioning occasion occurs, or when triggered by a positioning protocol, according to some embodiments. The measurement on the reference signal may according to some embodiments be performed selectively per carrier. According to some embodiments may the measurement on the reference signal be performed over multiple carriers, and further that the measurement on the reference signal may be transmitted either in a combined or separate per carrier positioning report.

The measurement on the reference signal may alternatively according to some embodiments be performed for as many antenna ports as the number of ports used for transmitting reference signals, which reference signals are transmitted by the network node 110, 120 and used for positioning measurements.

According to some embodiments may different measurements on the reference signal be performed on different carriers with an indication comprised in the reference signal measurement report. The measurements on the reference signal conducted for the positioning purpose may be different from those conducted for the mobility purpose, according to some embodiments.

### Action 606

This action is optional and may be performed within some embodiments.

The measurement on the reference signal may optionally be transmitted to a network node 110, 120, 140, such that the determination of the geographical position of the positioning target node 130 is enabled, using the transmitted signal measurement. Hence the determination of the position of the positioning target node 130 may be performed by base station 110 or by base station 120 or by positioning node 140 or any suitable network node in the network 100.

Note however, that according to some embodiments may the measurement on the reference signal be utilized by the positioning target node 130 itself, or to an entity comprised within the positioning target node 130, such that the determination of the geographical position of the positioning target node 130 by the positioning target node 130 itself, is enabled, using the transmitted signal measurement.

According to some embodiments may the performed measurements be transmitted in a combined or separate per carrier positioning report, and/or transmitted for as many antenna ports as the number of ports used for reference signals for positioning measurements.

### Action 607

This action is optional and may be performed within some embodiments.

The geographical position of the positioning target node 130 may optionally be determined, using the performed measurement on the reference signal.

According to some embodiments may the performed measurement on the reference signal be utilized for enhancing positioning methods such as fingerprinting positioning methods, Adaptive Enhanced Cell Identity (AECID) and/or hybrid positioning.

The performed measurement on the reference signal may however be utilized for reference cell selection and/or positioning neighbour list selection, according to some embodiments. According to some embodiments may positioning subframes be excluded when performing mobility, or general Radio Resource Management measurements.

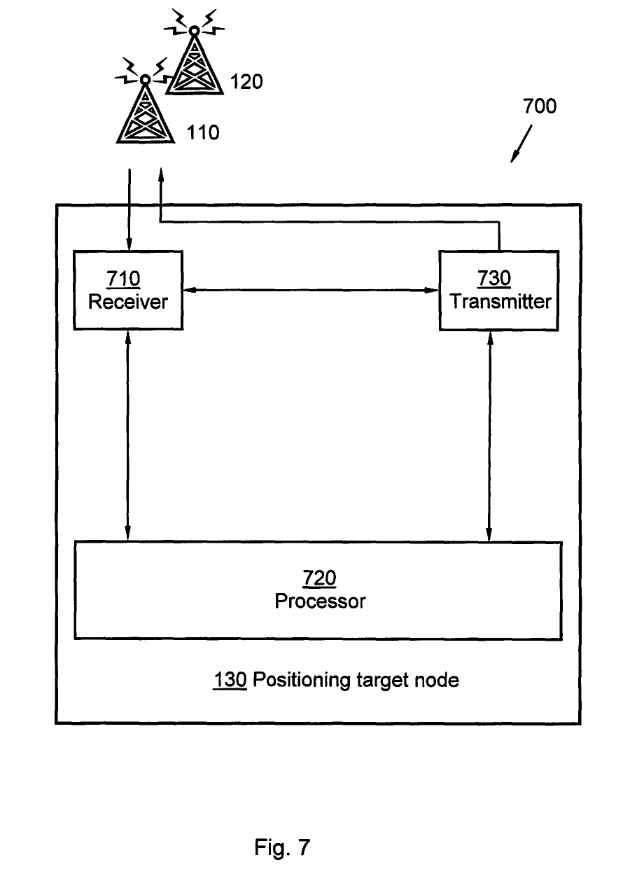

FIG. 7 is a block diagram illustrating embodiments of an arrangement 700 comprised in a positioning target node 130. The positioning target node may comprise a UE, according to some embodiments. The arrangement 700 is configured to perform any some or all of the method actions 601-607 for performing a measurement on a reference signal for positioning or for enabling location-based services in a wireless communication network 100. The arrangement 700 comprises a receiver 710, configured to receive a reference signal from a network node 110, 120. Further, the arrangement 700 comprises a processor 720. The processor 720 is configured to identify at least one positioning subframe comprised within the received reference signal, and to perform the measurement on the reference signal over the at least one identified positioning subframe.

The processor 720 may be represented by e.g. a Central Processing Unit (CPU), a processing unit, a microprocessor, or other processing logic that may interpret and execute instructions. The processor 720 may further perform data processing functions for inputting, outputting, and processing of data comprising data buffering and device control functions, such as call processing control, user interface control, or the like.

Further, according to some embodiments may the arrangement 700 comprise a transmitter 730. The optional transmitter 730 may be arranged to transmit information, confirming that the positioning target node 130 is able to perform measurements on the reference signal to the network node 110, 140, requesting such information according to some embodiments. Further, the optional transmitter 730 may be arranged to transmit the measurement on the reference signal, such that the determination of the geographical position of the positioning target node 130 may be enabled, using the transmitted measurement.

The receiver 710 may be further configured to receive a request, for confirming that the positioning target node 130 is able to perform measurements on the reference signal. In addition may the receiver 710 be configured to receive a request, to perform measurement on the reference signal over a positioning subframe, enabling positioning or location-based services.

The processor 720 may be further configured to determine the geographical position of the positioning target node 130, using the performed measurement, according to some embodiments.

For the sake of clarity, any internal electronics of the arrangement 700, not completely indispensable for understanding the present method has been omitted from FIG. 7.

The actions 601-607 to be performed in the arrangement 700 may be implemented through one or more processors 720 in the positioning target node 130, together with computer program code for performing the functions of the present actions 601-607. Thus a computer program product, comprising instructions for performing the actions 601-607 in the positioning target node 130 may perform the measurement on the reference signal, over at least one positioning subframe, when being loaded into the processor 720.

The computer program product mentioned above may be provided for instance in the form of a data carrier carrying computer program code for performing at least some of the actions 601-607 according to the present solution when being loaded into the processor 720. The data carrier may be e.g. a hard disk, a CD ROM disc, a memory stick, an optical storage device, a magnetic storage device or any other appropriate medium such as a disk or tape that may hold machine readable data. The computer program product may furthermore be provided as computer program code on a server and downloaded to the positioning target node 130 remotely, e.g. over an Internet or an intranet connection.

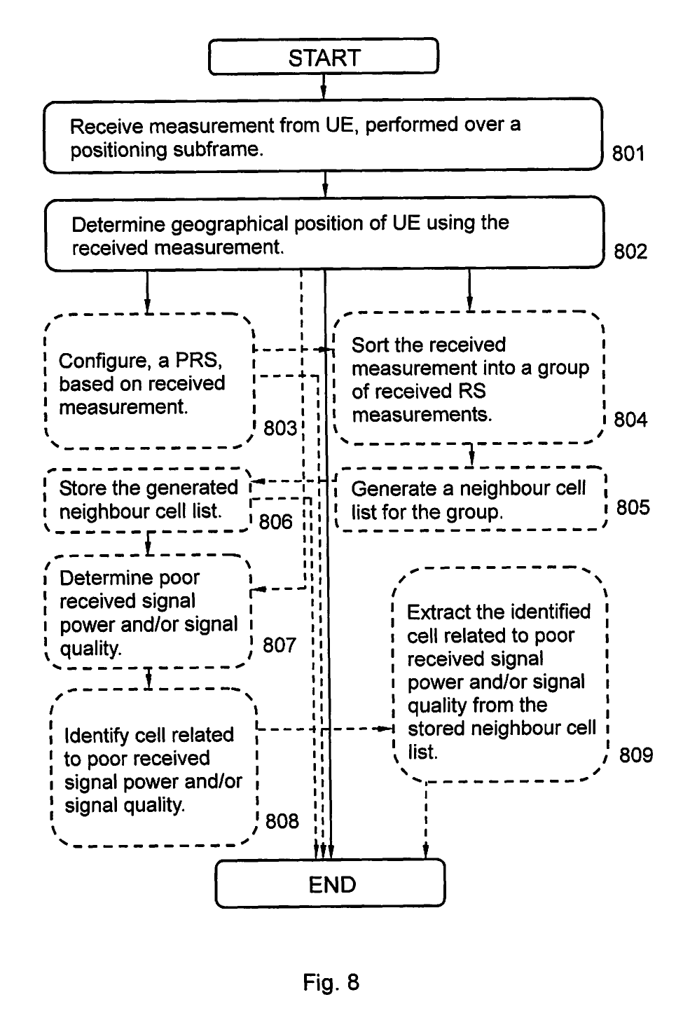

FIG. 8 is a schematic block diagram illustrating an example of a method in a network node 110, 120, 140 in a wireless communication network 100. The method aims at providing positioning or for enabling location-based services in a wireless communication network 100.

Thus the wireless communication network 100 may comprise a first base station 110, acting as serving base station for the positioning target node 130, and wherein the network node 110, 120, 140 may be the first base station 110, serving the positioning target node 130, or a positioning node 140, or any other base station 120 pr network node in the wireless communication network 100, according to some embodiments.

To appropriately obtain the measurement on the reference signal from the positioning target node 130, the method may comprise a number of actions 801-809.

It is however to be noted that some of the described actions are optional and only comprised within some embodiments. Further, it is to be noted that the actions 801-809 may be performed in a somewhat different order and that some of them, e.g. action 803 and action 804, may be performed simultaneously or in a rearranged order. Further, it is to be noted that some of the described actions are optional, e.g. actions 803-809, indicated by dashed lines in FIG. 8. The method may comprise the following actions:

A request to perform the measurement on the reference signal over a positioning subframe may optionally be sent to the positioning target node 130.

According to some embodiments may a check be performed, checking if the positioning target node 130 is able to perform measurements on the reference signal over positioning subframes before requesting the positioning target node 130 to perform measurements on the reference signal.

### Action 801

The measurement on the reference signal is received from the positioning target node 130. The measurement on the reference signal has been performed over at least one positioning subframe identified by the positioning target node 130 within a reference signal. The action of receiving the measurement on the reference signal from the positioning target node 130 may according to some embodiments comprise deriving a signal quality measurement for the reference signal, based on a Cell-specific Reference Signal (CRS) measurement, or a positioning reference signal (PRS) measurement.

### Action 802

A geographical position of the positioning target node 130 is determined, using the received measurement on the reference signal.

### Action 803

This action is optional and may only be performed within some embodiments.

A Positioning Reference Signal (PRS) may optionally be configured based on the received measurements on a reference signal, according to some embodiments.

### Action 804

This action is optional and may only be performed within some embodiments.

The received measurements on a reference signal, received from the positioning target node 130 may optionally be sorted into a group of received reference signal measurements, according to some embodiments.

### Action 805

This action is optional and may only be performed within some embodiments.

A neighbour cell list for the group of received measurements on a reference signal, which the received measurement on the reference signal from the positioning target node 130 has been sorted into, may optionally be generated according to some embodiments.

### Action 806

This action is optional and may only be performed within some embodiments.

The generated neighbour cell list, associated with the group of received measurements on the reference signal which the received measurement on the reference signal from the positioning target node 130 has been sorted into may optionally be stored, according to some embodiments.

The storage of the thus generated neighbour cell list may be made in a database.

### Action 807

This action is optional and may only be performed within some embodiments.

It may optionally be determined that the received measurement on a reference signal from the positioning target node 130 indicates poor received signal power and/or signal quality, according to some embodiments.

### Action 808

This action is optional and may only be performed within some embodiments.

The cell related to the received measurement on a reference signal, which has been determined to indicate poor received signal power and/or signal quality, may optionally be identified.

### Action 809

This action is optional and may only be performed within some embodiments.

The identified cell may be extracted from the stored neighbour cell list. Thereby may cells associated with poor received signal power and/or signal quality be excluded from the stored neighbour list, such that the positioning target node 130 could avoid camping on that cell.

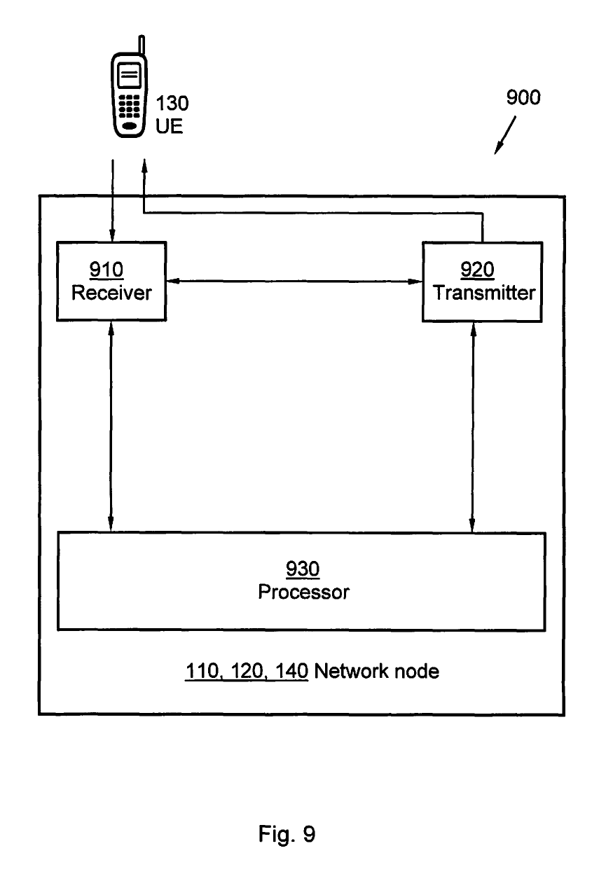

FIG. 9 is a block diagram illustrating embodiments of an arrangement 900 comprised in a network node 110, 120, 140. The network node 110, 120, 140. The arrangement 900 is configured to perform at least some of the actions 801-809 for positioning or for enabling location-based services in a wireless communication network 100.

For the sake of clarity, any internal electronics of the arrangement 900, not completely indispensable for understanding the present method has been omitted from FIG. 9.

The arrangement 900 comprises a receiver 910 configured to receive a measurement from a positioning target node 130, the measurement that has been performed over at least one positioning subframe identified by the positioning target node 130 within a reference signal. The arrangement 900 further comprises a processor 930. The processor 930 is configured to determine a geographical position of the positioning target node 130 using the received measurement on a reference signal.

Thereby may the determination of the geographical position of the positioning target node 130 be enabled, using the received measurement on a reference signal. The arrangement 900 according to some embodiments also comprises a transmitter 920, configured to transmit radio signals to the positioning target node 130.

The processor 930 may be represented by e.g. a CPU, a processing unit, a microprocessor, or other processing logic that may interpret and execute instructions. The processor 930 may perform data processing functions for inputting, outputting, and processing of data including data buffering and device control functions, such as call processing control, user interface control, or the like.

It is to be noted that the described units 910-930 comprised within the arrangement 900 may be regarded as separate logical entities, but not with necessity as separate physical entities. Any, some or all of the units 910-930 may be comprised or co-arranged within the same physical unit. However, in order to facilitate the understanding of the functionality of the arrangement 900, the comprised units 910-930 are illustrated as separate physical units in FIG. 9.

Any, all or some of the described actions 801-809 in the arrangement 900 may be implemented/performed using one or more processors 930 in the network node 110, 120, 140, together with computer program code for performing the functions of the present actions 801-809. Thus a computer program product, comprising instructions for performing the actions 801-809 in the network node 110, 120, 140 may perform the method for obtaining a measurement on a reference signal for the purpose of positioning or enabling location-based services in a wireless communication network 100, when being loaded into the processor 930.

The computer program product mentioned above may be provided for instance in the form of a data carrier carrying computer program code for performing at least some of the actions 801-809 according to the present solution when being loaded into the processor 930. The data carrier may be e.g. a hard disk, a CD ROM disc, a memory stick, an optical storage device, a magnetic storage device or any other appropriate medium such as a disk or tape that may hold machine readable data. The computer program product may furthermore be provided as computer program code on a server and downloaded to the network node 110, 120, 140 remotely, e.g. over an Internet or an intranet connection.

The terminology used in the detailed description of the particular exemplary embodiments illustrated in the accompanying drawings is not intended to be limiting of the present methods and arrangements. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it may be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

1-18. (canceled)

19. A method in a positioning target node, for performing measurement related to one or both of a received signal power and a signal quality of a reference signal for enabling location-based services in a wireless communication network, or for positioning according to a positioning method in the group of positioning methods comprising Enhanced Cell ID (E-CID), fingerprinting positioning methods, Adaptive Enhanced Cell Identity (AECID), and hybrid positioning, wherein the method comprises:
receiving the reference signal from a network node;
identifying at least one positioning subframe comprised within the received reference signal; and
performing a measurement on the reference signal over the at least one identified positioning subframe, which is a low-interference subframe.

20. The method according to claim 19 further comprising transmitting the performed measurement to a network node.

21. The method according to claim 20 wherein the network node is a base station serving the positioning target node or a positioning node, or any other base station or network node in the wireless communication network.

22. The method according to claim 20, comprising performing the measurement on the reference signal selectively per carrier or over multiple carriers, and transmitting the performed measurements in a combined or separate per carrier positioning report, or for as many antenna ports as the number of ports used for reference signals for positioning measurements.

23. The method according to claim 19 further comprising determining a geographical position of the positioning target node using the performed measurement.

24. The method according to claim 19 wherein the reference signal is a positioning reference signal (PRS) or a cell-specific reference signal (CRS).

25. The method according to claim 19, further comprising:
receiving a request from the network node, for confirming that the positioning target node is able to perform the measurement on the reference signal over the positioning subframe; and
transmitting information to the network node, confirming that the positioning target node is able to perform the measurement on the reference signal over the positioning subframe.

26. The method according to claim 19, wherein the measurement on the reference signal is performed when a positioning occasion occurs, or when triggered by a positioning protocol.

27. The method according to claim 19, wherein the performed measurement on the reference signal is utilized for one or both of reference cell selection and positioning neighbor list selection.

28. An arrangement in a positioning target node, for performing a measurement related to a received signal power or signal quality of a reference signal for enabling location-based services in a wireless communication network, or for positioning according to a positioning method in the group of positioning methods comprising Enhanced Cell ID (E-CID), fingerprinting positioning methods, Adaptive Enhanced Cell Identity (AECID), and hybrid positioning, wherein the arrangement comprises:
a receiver configured to receive a reference signal from a network node; and
a processor configured to identify at least one positioning subframe comprised within the received reference signal, and to perform the measurement on the reference signal over the at least one identified positioning subframe, which is a low-interference subframe.

29. The arrangement according to claim 28, further comprising a transmitter configured to transmit the performed measurement to a network node.

30. The arrangement according to claim 28, wherein the processor is further configured to determine a geographical position of the positioning target node using the performed measurement.

31. A method in a network node that is configured for operation in a wireless communication network, said method for enabling location-based services in a wireless communication network, or for positioning according to a positioning method in the group of positioning methods comprising Enhanced Cell ID (E-CID), fingerprinting positioning methods, Adaptive Enhanced Cell Identity (AECID), and hybrid positioning, and said method comprising:
receiving a measurement from a positioning target node that relates to a received signal power or signal quality and has been performed over at least one positioning subframe, which is a low-interference subframe, identified by the positioning target node within a reference signal; and
determining a geographical position of the positioning target node using the received measurement.

32. The method according to claim 31, wherein receiving the measurement from the positioning target node comprises deriving a signal quality measurement for the reference signal, based on a cell-specific reference signal (CRS) measurement or a positioning reference signal (PRS) measurement.

33. The method according to claim 31, wherein the network node is a base station serving the positioning target node or a positioning node or any other base station in the wireless communication network.

34. The method according to claim 31, further comprising configuring a positioning reference signal (PRS) based on the received measurement.

35. The method according to claim 31 further comprising:
sorting the received measurement into a group of received reference signal measurements;
generating a neighbor cell list for the group of received reference signal measurements;
storing the generated neighbor cell list;
determining if the received measurement from the positioning target node indicates one or both of poor received signal power and signal quality;
identifying the cell related to the poor received signal power or signal quality; and
extracting the identified cell from the stored neighbor cell list.

36. An arrangement in a network node, for enabling location-based services in a wireless communication network, or for positioning according to a positioning method in the group of positioning methods comprising Enhanced Cell ID (E-CID), fingerprinting positioning methods, Adaptive Enhanced Cell Identity (AECID), and hybrid positioning, and wherein the arrangement comprises:
a receiver configured to receive, from a positioning target node, a measurement that relates to a received signal power or signal quality and has been performed by the positioning target node over at least one positioning subframe, which is a low-interference subframe, identified by the positioning target node within a reference signal; and
a processor configured to determine a geographical position of the positioning target node using the received measurement.
